(19) United States
(12) Patent Application Publication
(10) Pub. No.: US 2013/0304563 A1
(43) Pub. Date: Nov. 14, 2013

(54) METHOD, SYSTEM AND APPARATUS FOR FINDING, ORGANIZING, RANKING AND VISUALIZING COMBINABLE OFFERS

(71) Applicants: Christopher Haupt, (US); Stephen Marcu, (US)

(72) Inventors: Christopher Haupt, (US); Stephen Marcu, (US)

(21) Appl. No.: 13/466,796

(22) Filed: May 8, 2012

(51) Int. Cl. G06Q 30/02

(52) U.S. Cl. 705/14.35; 705/14.1

(57) ABSTRACT

The present invention contemplates a variety of techniques including a computer implemented method. The method comprises receiving a plurality of offers from a plurality of entities, combining offers from the plurality of offers into an offer stack, wherein all offers of the offer stack can be applied jointly to a transaction and presenting the offer stack to a customer. Some of the entities can have one or more membership programs, and offers can be presented in one or more membership programs.

### FIELD OF THE INVENTION

The present invention relates to a purchasing assistance application, more specifically to a system and method for increasing benefits to consumers by organizing and analyzing consumers' existing organization membership programs.

### BACKGROUND

Many consumers are members of various organizations' programs, such as automobile associations, credit card programs, local sports clubs, volume purchasing clubs, professional societies, etc. What consumers don't always understand is that with those memberships, there are often ancillary benefits besides the obvious ones. For instance, membership in the largest automobile club in the US, the American Automobile Association (AAA), includes not just the ability to hire a tow truck, fix a flat, or organize a vacation with a set of maps. The AAA membership also includes various discounts at many merchants around the country.

Many merchants have loyalty programs, run sales and seasonal promotions, or have certain affinity marketing efforts in an attempt to attract new customers or retain existing customers. Customers frequently know about the most popular of such rewards and offers, but many other rewards and offers are often overlooked.

When a consumer does recognize that she has a particular offer that she can use, she has to be responsible to remember when and where to use it, and what conditions apply for its use. If successful, the consumer then derives some benefit (cheaper price, reward points, cash back, etc). What a consumer doesn't typically understand is that she could get more, perhaps much more, if she applied multiple offers together in combination from disparate sources. Figuring out which combinations are applicable and not mutually exclusive is a time consuming process and often a trial and error process, for most consumers.

There are applications that help find initial, single “deals”, such as mobile phone apps Vidappe and RewardExplorer, but they only show single offers for a particular business based on the location of the mobile phone.

Various web sites also exist that show the “best” deal for a particular kind of purchase (e.g. travel) including Expedia.com. There are also “deal of the day” sites like Groupon.com or LivingSocial.com that just show a deal with a specific expiring time and date.

Other web sites and membership programs exist that show just that organization's offerings, as a complete list (e.g. AAA, American Express benefits listings). But these sites and programs are hard to track in order to find a deal that is interesting to one individual customer.

There are applications like FourSquare that allow a visitor of a business location to provide “tips” about possible deals, but such tips aren't curated or easily identifiable.

### SUMMARY

The present invention contemplates a variety of methods and systems for finding multiple sources of organization program offerings and harvesting them into a single database. As the offer data is gathered, the data is cleaned up and gaps in data are corrected through cross-references from alternative data sources. Offer information is then analyzed and parsed to extract calculated relative values and to determine the conditions under which any of the offers can be used in combination withother offers. Offer information and its related metadata is then scored and arranged for easy access by a visualization and feedback process that can be used for customer interaction and consumption. End-user customers may also rate and comment on current offers and their combinations as well as suggest new combinations or offers that are then fed back into the overall system.

In one embodiment, the system organizes benefits, rewards, coupons, deals and other offers from various organizations. Then the system analyzes theses offers to discover optimal ways to use one or more offers in combinations. A combination of offers that can be utilized together is referred to as a stack. The optimal stack and other alternative stacks are visualized and listed in a relative ranking. The consumers can select the select the most rewarding stack for their desired activity. Additionally, the consumers can give further feedback on the success and value of using the stack, or suggest a alternative stack that is not listed.

Other aspects of the technology introduced here will be apparent from the accompanying figures and from the detailed description which follows.

### BRIEF DESCRIPTION OF THE DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates an example process of organizing, analyzing and presenting the offer data;

FIG. 2 illustrate an example data model for organizing the offer data;

FIG. 3 is a flow chart illustrating a method for providing offer combination (stack) analysis and model maintenance;

FIG. 4 is a screenshot of an example application listing various offers;

FIG. 5 is a screenshot of an example application providing consumer feedback mechanism

FIG. 6 is a flow chart illustrating an example method for a data acquisition process;

FIG. 7 is a flow chart illustrating an example method preparing visualization information through an API and providing a feedback path for various kinds of end-user supplied data; and

FIG. 8 is a screenshot of an example application listing various offers on a map.

### DETAILED DESCRIPTION

References in this specification to “an embodiment,” “one embodiment,” or the like, mean that the particular feature, structure, or characteristic being described is included in at least one embodiment of the present invention. Occurrences of such phrases in this specification do not necessarily all refer to the same embodiment.

Stackable Offers are a set of deals, offers, discounts, rewards, or benefits from one or more sponsoring businesses, programs, and/or sources that can be applied to a particular consumer or business transaction as a combination of one or more. The combination of offers is called a “stack”, an “offer stack”, or a “combination stack”.

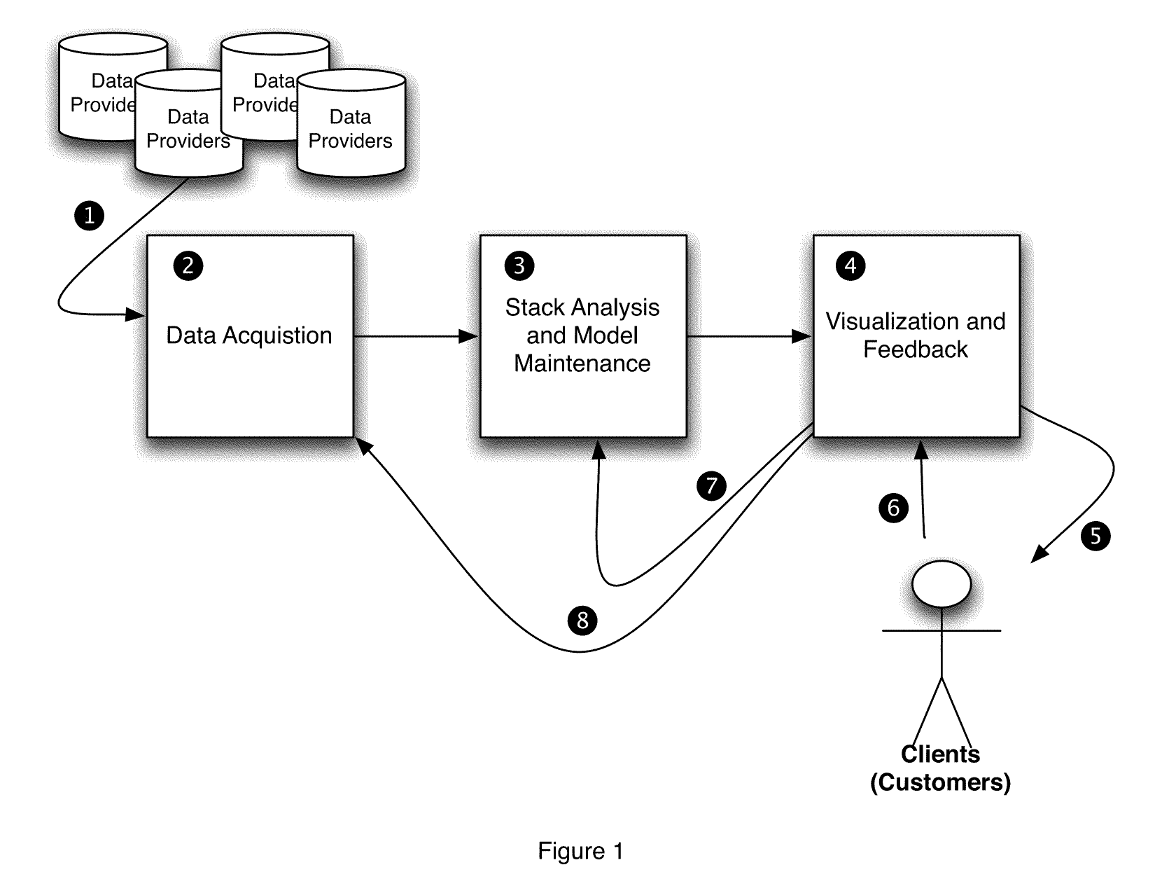

In one embodiment, there are three sub-systems in a system for finding, organizing, ranking and visualizing combinable offers (also referred to as “the system” or simply “system”): Data Acquisition (FIG. 1, Item 2); Stack Analysis and Model Maintenance (FIG. 1, Item 3); and Stack Visualization and Feedback (FIG. 1, Item 4).

Data Acquisition

The Stackable Offer mechanism operates on a rich collection of domain information to generate its data model. Data is collected from multitude of sources including, for example:
Organizations with Membership programs;
Businesses with Loyalty programs;
Public and Private clubs;
Retailer Sales;
Non-profit, Educational, or Governmental Offers;
Individual Rewards offerings;
Credit Card Benefits; and
Cash Back Programs.

Data may arrive in the Stackable Offer Data Acquisition (DA) sub-system via manual entry, automated data feeds or APIs, or bulk import from files.

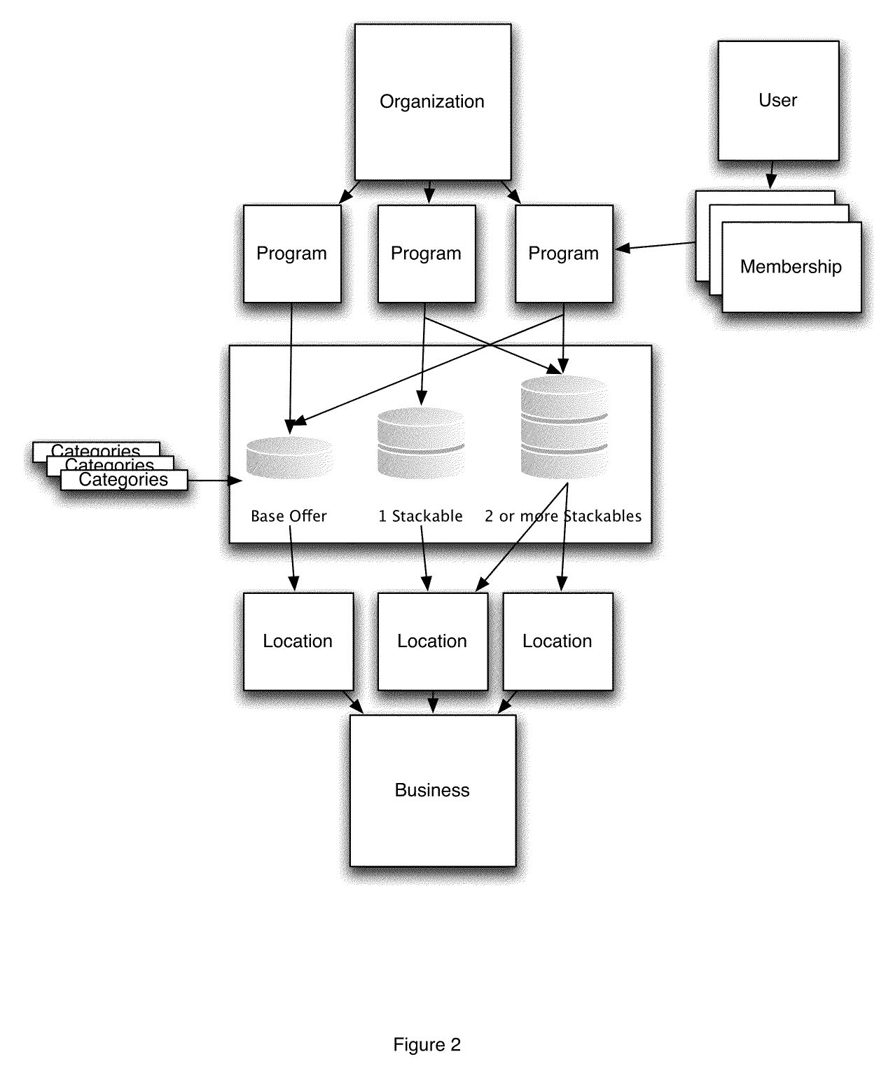

Data used by the system is organized into a model representing the relationships between entities as illustrated in FIG. 2.

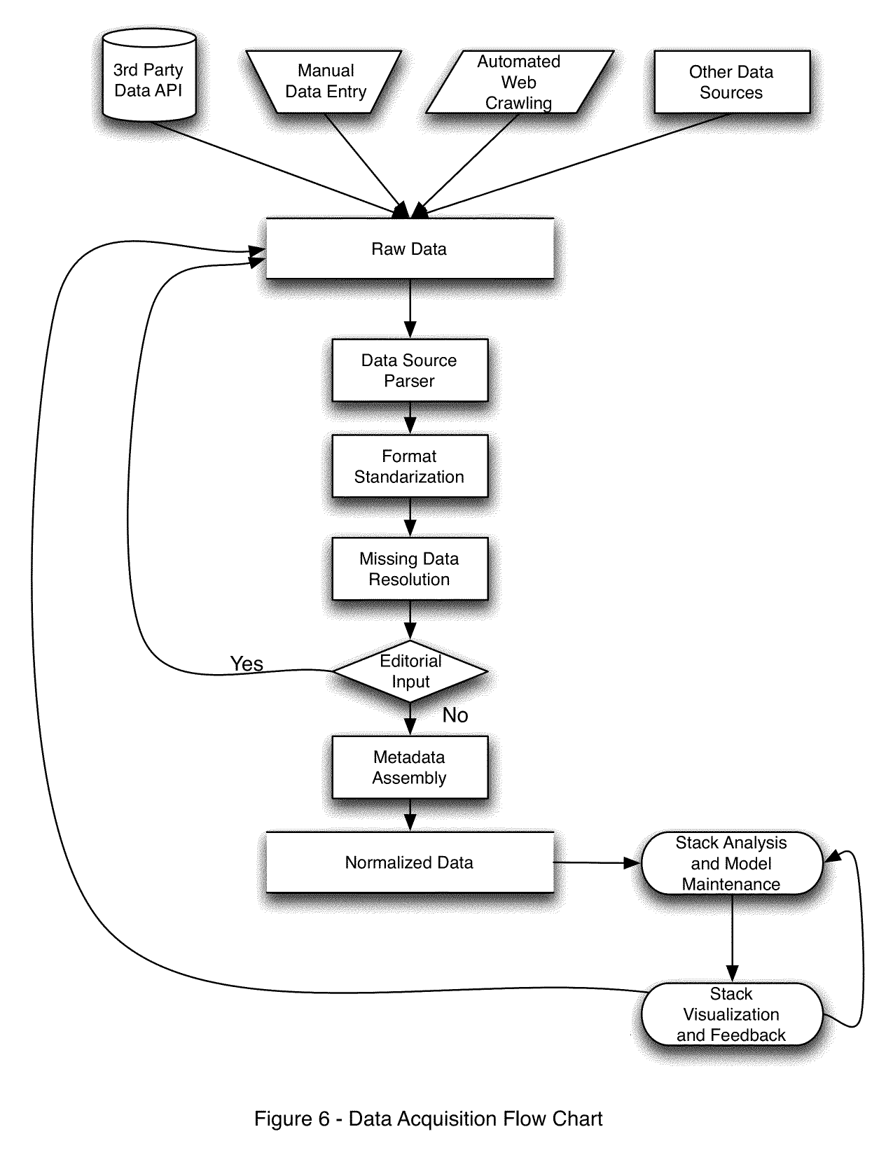

FIG. 6 is a flow chart of an example work flow of the Data Acquisition sub-system. As the data from different sources are merged into the system, each piece of information is first converted into a standard format, then for pieces of key information that may be missing (e.g. location data), the system attempts to resolve such gaps of missing information by searching through alternate sources until either the missing piece of information can be filled in, or a configurable amount of effort has been expended, and the system gives up.

During the data normalization process, human editorial staff may intercede and manually alter the data to provide corrections, add new information, or remove unwanted entries. Data is finally assembled together for rapid access within the Stack Analysis and Model Maintenance sub-system.

The Data Acquisition component can be refined as the data set grows to improve the filtering and normalization process. Feedback from end-user ratings, data usage statistics, suggested offers or combination stacks, and other input may be associated with normalized data for further processing.

Data Model Details

FIG. 2 illustrates a form of an abstract data model that could represent data involved in this invention.

Organizations may represent groups, clubs, financial institutions and others who offer membership programs. Users identify themselves as members of these various organizations. Organizations maintain key top-level metadata about themselves that are shared across all programs.

Organizations may be further sub-divided into programs. Programs represent the actual membership group offered by the organization. A user may be a member of one or many programs. An organization can have at least one default, self-named program if it doesn't naturally offer programs of its own.

Offers are associated with programs. Offers may represent some reward, benefit, deal, or perk offered through membership of the organization that can be redeemed with one or more specific same-party or third-party businesses or other entities. Offers fall into one of two kinds:

1. “Base” Offers; and

2. “Stackable” Offers.

Base Offers are the kind of offers that embody a specific usage with a specific party (i.e. a 1:1 linking). For example, a car rental company offers a deal of 15% off rental price. The bulk of offers in the data acquisition stream are typically Base Offers. Base offers have some value or discount, and may have an expiry date. Base offers are categorized into broad groupings associated with the kind of third-party they are typically used with (see Category).

Stackable Offers are offers that can be combined with other offers (or used alone). Stackable offers usually fall into one of a number of broad sub-types such as:

1. Cash Back;

2. Points; and

3. Discounts.

A Stackable offer may be constrained in its specific use and on what kind of Base offers or type of third-party transaction or business it can be applied. Stackable offers may be used:

1. Everywhere (e.g. 1% cash back on any transaction of a credit card)

2. A subset of third-party businesses or types of offers

3. Some other usage constrained case

A Stackable combination is typically suggested through the invention's data analysis sub-system, but candidate offers and combinations can also be suggested by end-user customers of the system. Both system generated and user-sourced combinations can be rated, compared, shared, and used.

Offers are redeemed at Businesses (any third-party entity, even for an entity that is not technically a “business”). Businesses may have one or more locations associated with them. A location will be either a physical place with geo-coded and human friendly location information and contact information (phone, email, fax, web site, social media). A location can also represent a purely virtual/online place (web only businesses). A business will have one or more Locations, often with a single online Location and one or more physical Locations.

Offers directly associate with a Business/Location-tuple, where the Location component may include one or more Locations.

A User profile maintains a consumer's identity. When registered, the User's profile becomes associated with certain usage and demographic data that is discovered over time. All User interaction forms a log that is associated with that account and can be used as feedback that can improve the system.

Users associate themselves with Organization Programs through Memberships. Memberships connect the models together and capture specific Membership info that the User provides.

Stack Analysis and Model Maintenance

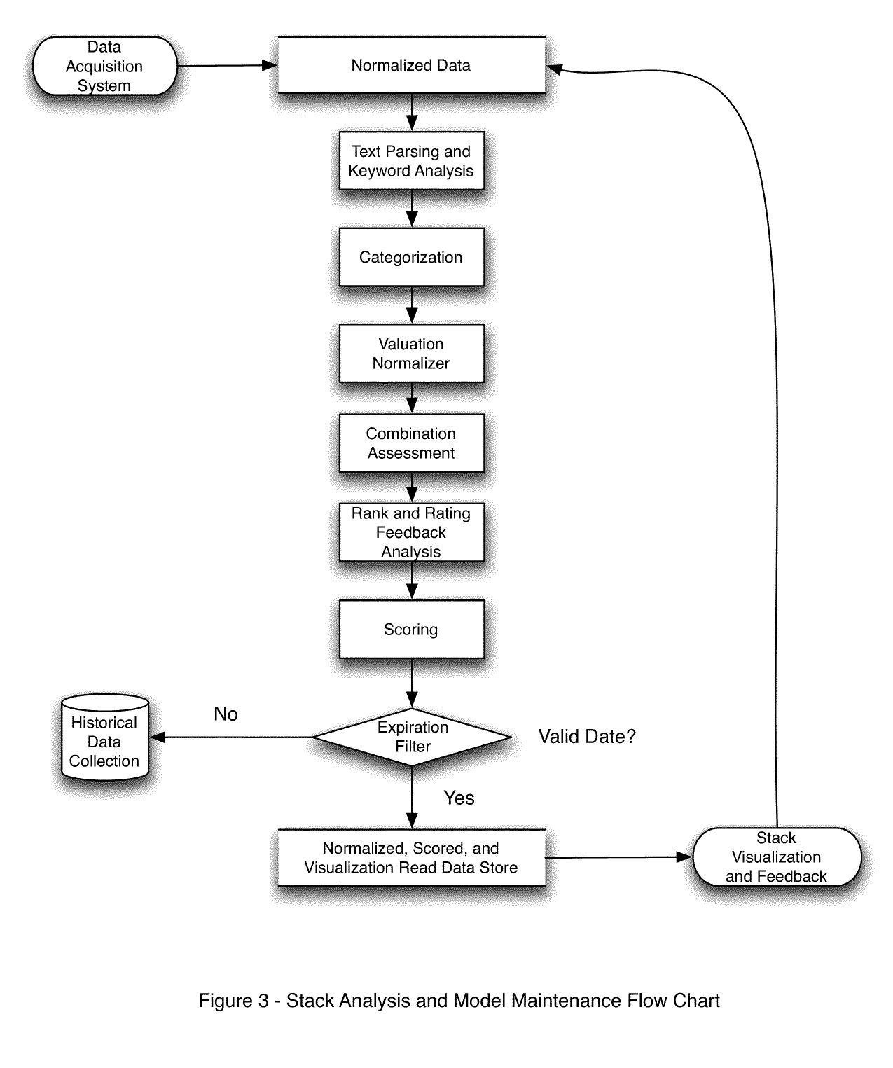

The Stack Analysis and Model Maintenance (SAMM) sub-system takes as input raw, normalized data from the Data Acquisition (DA) sub-system (FIG. 1, and FIG. 3).

SAMM performs a sequence of parsing, categorization, statistical valuation and comparison, and scoring steps on raw offer info, and associates those results with their associated Organizations' Programs, as well as the applicable Business Locations on which they may apply, particularly to form compelling combinations. (See FIG. 3)

The Categorization step performs assisted curation—a combination of human editorializing and machine pattern matching—of the raw data and assigns each offer into one or more categories of business (e.g. Travel related, Entertainment, Food, Health, etc.). The categorization step also determines if the offer is a base-offer—one which applies to a specific redemption scenario—or a stackable offer that may be applied in a variety of scenarios and in combination with other offers.

SAMM next examines the terms and conditions of the offer, and performs a relative value calculation to allow an observer to compare and contrast two offers (e.g. to help differentiate between a 10% off offer versus a $10 Rebate offer). SAMM computes the relative value through a combination of ranking of the face value of the specific offer and comparing against current and historical valuations of other offers of similar application.

SAMM takes the categorization and valuation inputs, as well as optional modifier scoring coefficients provided by editorial administrators and rating information and success/failure data from customers to arrive at a final relative score for each offer. Scores may then be used to get relative stack orderings of competing offers within a category or across the system.

Finally, SAMM also tracks data lifecycle information. Offers, as well as other raw information passed in from the DA sub-system, may have expiry metadata associated with it. If data is no longer valid after a period of time, it can be automatically flushed from the system or flagged for review and extension by the editorial administrators.

Stack Visualization and Feedback

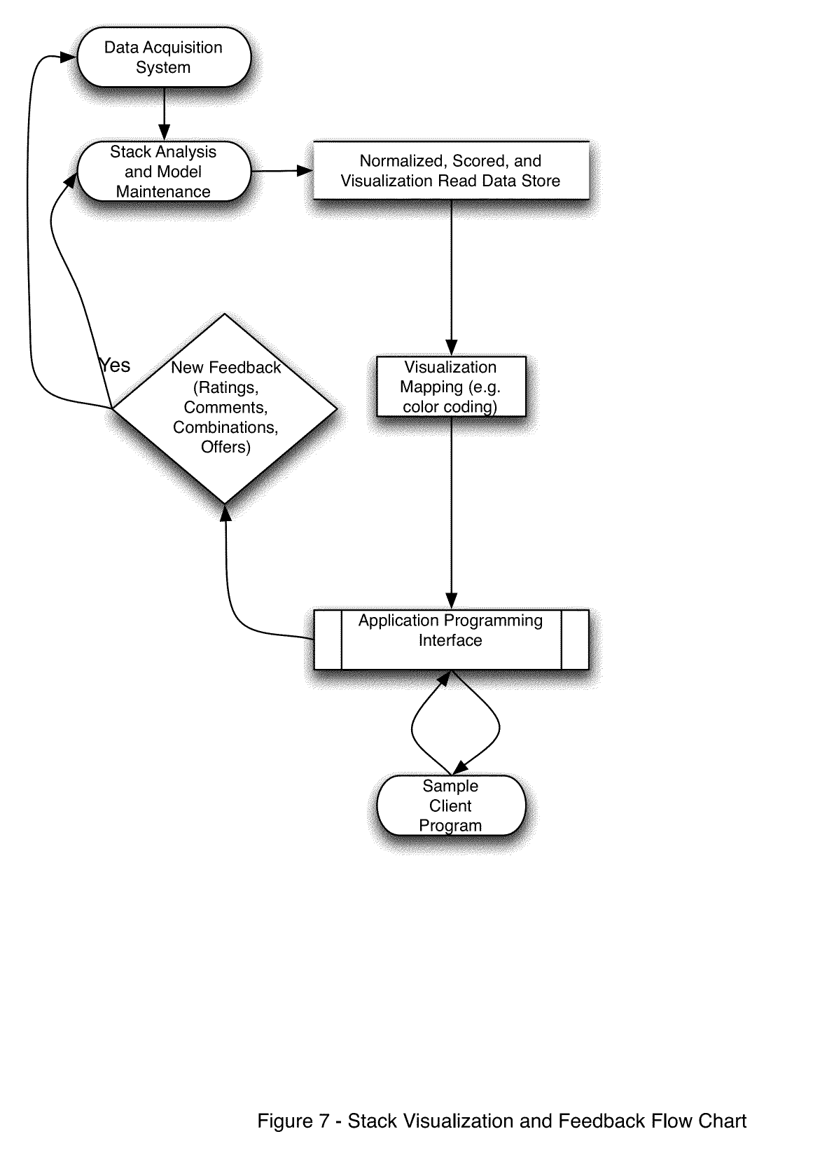

The Stack Visualization and Feedback (SVF) sub-system takes the calculations and prepared data from the SAMM sub-system, and makes it available for end-user (customer clients) use and review (see FIG. 7).

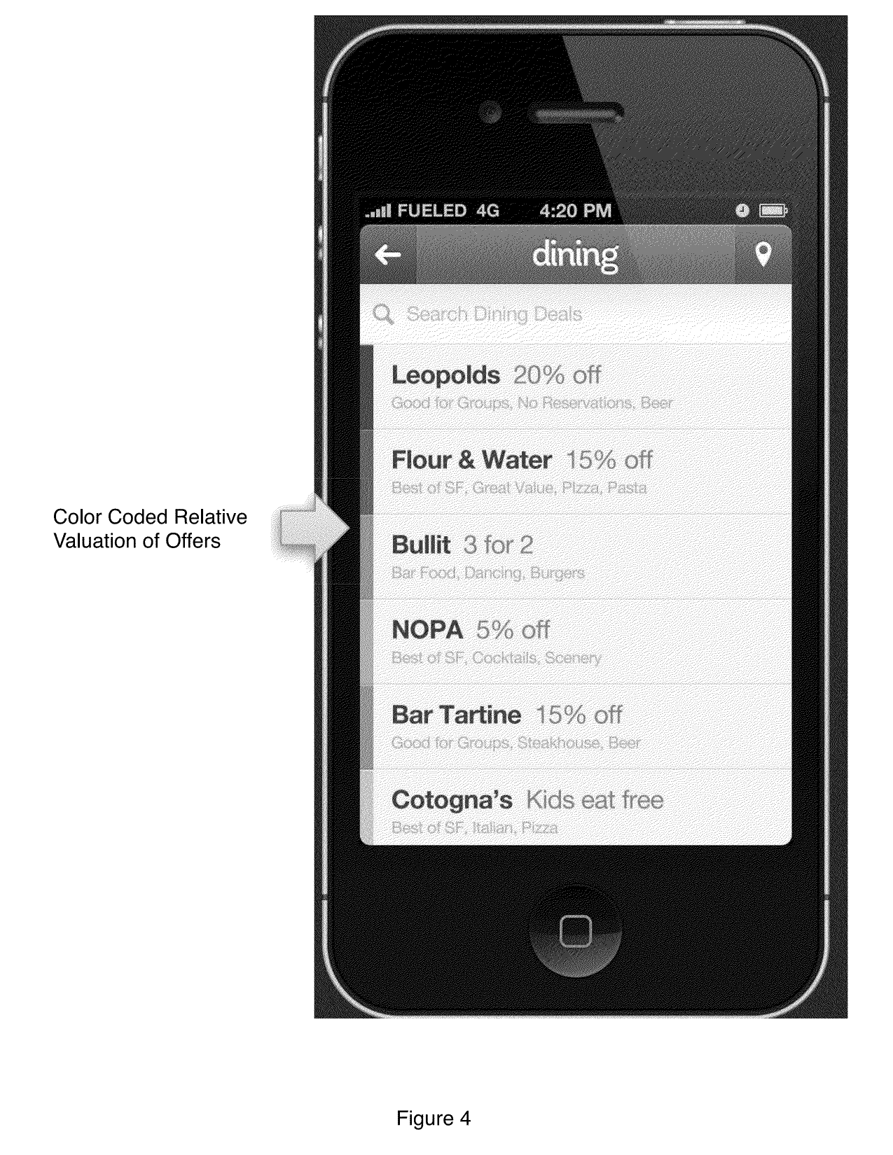

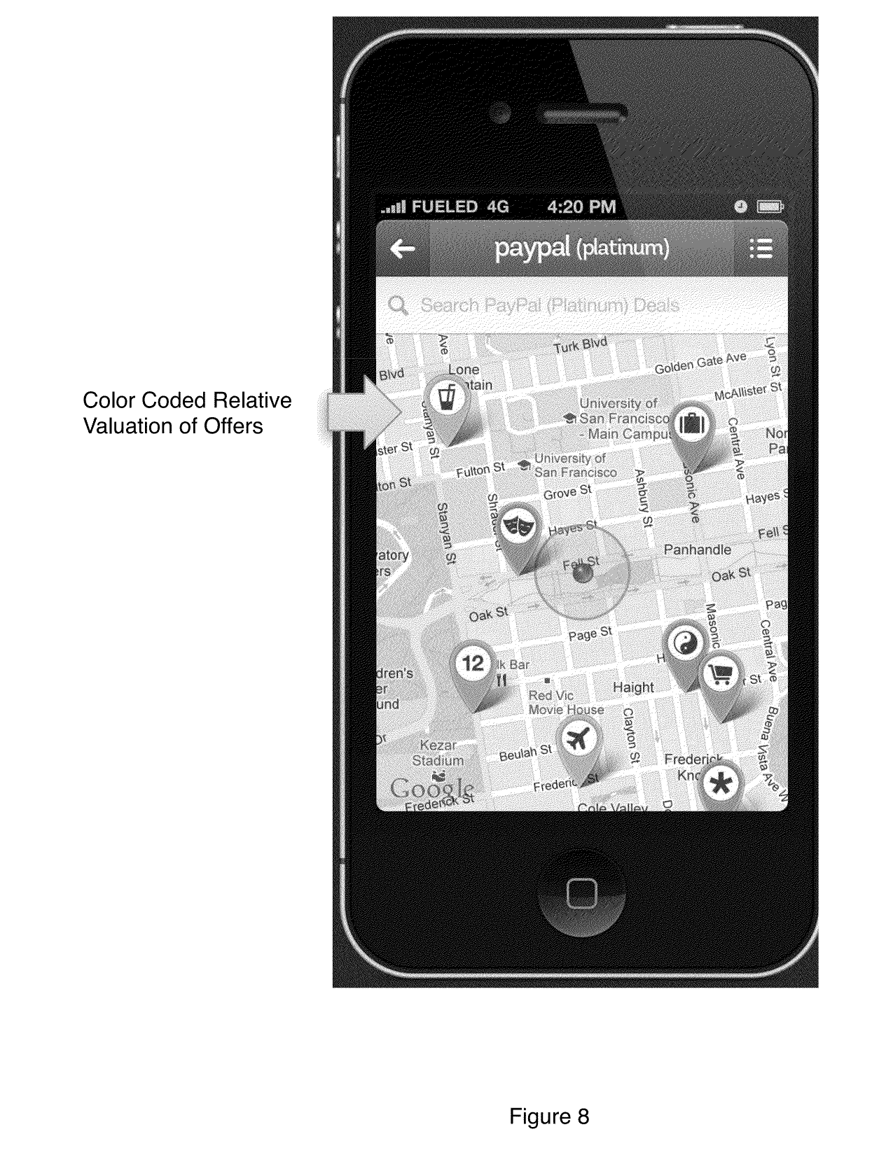

The SVF provides an application programming interface (API) and graphical user interface (GUI) guidelines for displaying model information. In particular, SVF describes the workflow for permitting the search, discovery, geolocation, comparison, usage, and feedback/review of offers associated with particular Organization Programs associated with the User through Memberships. The system uses the API data and GUI guidelines to provide informative info-graphics that allow quick comparison of relative values of deals through visual coding (such as via color) in whichever representation is chosen (e.g. in a list or as pins on a map. See example implementations in FIG. 4 and FIG. 8).

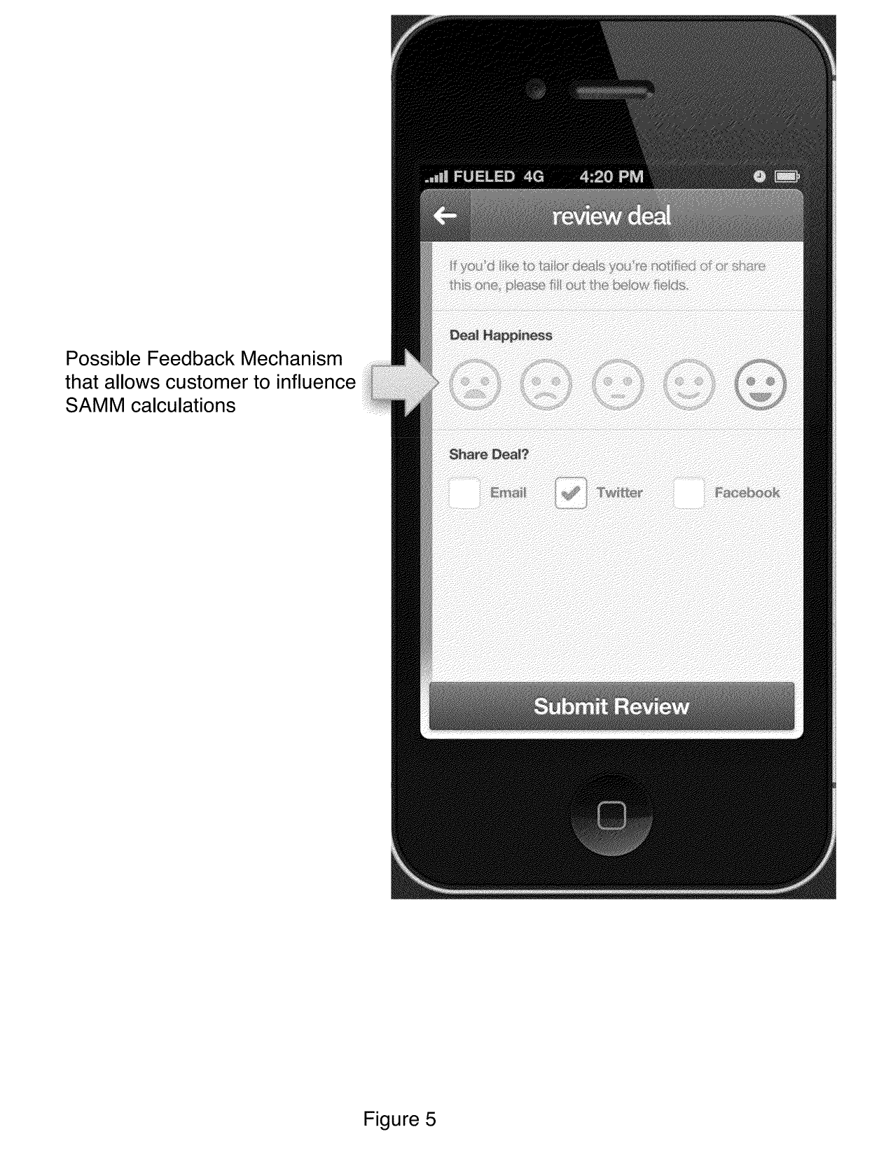

The SVF also specifies a protocol that can be used to collect customer feedback regarding the relative value of the offer or combination stack, whether the offer or its suggested stackable offers worked at all, and any free-form information desired (See FIG. 5 for sample implementation). The SVF also allows customers to suggest new individual offers, new combination stacks of offers, or proposed modifications of existing combinations.

Feedback and offer/combination information collected by the SVF (FIG. 1, Step 6) can flow back to the SAMM sub-system (FIG. 1, Step 7) where it is used to immediately influence the active valuation and scores of offers and combinations. Feedback may also flow back to the DA sub-system (FIG. 1, Step 8), where it is associated with the original raw data items and may be used to alter the manual and automated data collection filters and resultant offers and combination set calculations.

Computer Application

In one embodiment, at least part of the system can be implemented as a computer application. The application can utilize the system's offer oriented API and back-end services to give customers fun, engaging, and useful ways to “Show Me MY Deals”. The service includes a number of components:

1. Database containing the System core data architecture representing Organizations, Programs, Offers (e.g. Deals), Businesses and other objects;
2. A RESTful API service providing public and secure access to the Database and conforming to Representational State Transfer (REST) constraints;

### 3. Native Mobile Clients (e.g. iOS or Android);

4. A private Admin service that provides System's staff the means of manipulating the data (import, export, editing), and seeing a business Dashboard;
5. Miscellaneous operations oriented tools and scripts that help facilitate data management and daily sysops;
6. Internal and External performance and resource monitors; and
7. An external marketing Website.

The system at its core is an aggregation platform for integrating organizations, their offers and related merchants in a way that can easily lead to discovery and use by end-users. In the process the System learns key demographic and analytical information that can allow a company to drive the business and evolve as a marketing and advertising platform.

The system is designed so that authorized clients may use its data (through the API) without requiring a full User profile. Anonymous access to the data still results in the collection of Analytics, but it is only associated with broad identifiers such as client app, version, etc.

Once registered, a User profile maintains the customer's identity, using email as the username, and stores a salted password for authentication. When registered, the User's profile becomes associated with certain usage and demographic data that is discovered over time. All User interaction with use of offers, ratings or feedback, sharing, API use (including searches), bookmarks, and other activity form a log that is associated with that account. Analytics data survives after a User account is removed, but with the contact and identify information removed.

To make use of the system, Users associate themselves with Organization Programs through Memberships. Memberships join the models together and capture specific Membership info that the User cares to store (e.g. membership numbers, expiry info, etc.). User analytics discussed above typically also link with particular memberships.

When System is aware of a User's Memberships, that information may also be used to improve relevant search results, help with notifications, etc.

Categories and Tags

Offers are associated with one or more Categories that help identify the interest areas in which the offers fall (such as Dining, Travel, etc). Categories are usually helpful in client apps to help improve discoverability.

Tags are simple keywords that can be associated with Offers, Organization Programs, and Businesses to allow system editorial help in labeling, provide hints for search tools, and help users in understanding what an item is in a few short, standardized words.

Analytics

System collects data in a number of ways:

1. Client-side UI instrumentation using third-party services (e.g. Urban Airship);
2. Feature/Behavior Usage that System maintains (e.g. using certain client features that trigger specific APIs like offer usage);
3. Back-end API metrics and logging that associated specific client id, version, other metadata, and user if available with API call; and
4. Back-end Admin Dashboard analytics that help improve back-office workflow and process.

Application Programming Interface (API)

In one embodiment, the System API service is used for end-user client activity and internal administrative web apps. The API in general it is a RESTful API utilizing HTTP (SSL/TLS1), end-user authentication initially using Basic Authorization when needed. For clients that do not support the full set of HTTP methods (e.g. PUT, DELETE, etc.), an option request parameter “_method=METHOD” may be provided on a POST or GET call to simulate the desired verb. The API follows best practice to all degrees practical, and attempts to be friendly to clients that are in rough network environments (e.g. idempotency).

Clients of the API can identify themselves with certain HTTP headers, for example:

1. X-BC-Version: (a version string described below); and
2. X-BC-Client: (an assigned client-id identifier token).

The version string is composed of the following components for Client Apps: “1.0.0 [OS Version; HW Identifier; Local Info; Screen Rez];” here the version number uses a Major.Minor.Patch scheme. Requests without the required HTTP headers will be rejected.

The API is versioned, and the API version forms the first path element of the API endpoint. Versions can be in the form of “vN”, where N is an incrementing integer starting with “1”.

The Client API exposes the Data Model components described above that are appropriate for non-secure users (typically Read Only access to much of the model). An Admin API provides a secure internal channel to manipulate the entire model.

The API payload format is JSON and results are currently offered only in English. The result pay load is delivered in a JSON envelope of the general form:

{
“meta” : {“status”: “http status code”, “message”: “error message if an
error”, “code”: “internal error code if an error”, “moreInfoUrl”: “url to
documentation about this error”, “selfUrl”: “canonical URL for the
resource targeted by this request”},
“data” : “PAYLOAD OF CALL GOES HERE, FORMAT
VARIES”,
“pagination” : {“total”: “total number of items available when data
is a collection”,

“nextUrl: “next page of results, if any”,
“prevUrl”: “previous page of results, if any”,
“limit”: “max number of items to return in this request”,
“offset”: “starting location in array of results, 0 based”}

}

When a list request is made, the pagination data will be included in the result payload. Next and Previous URL optional values will be provided if there is data in one direction or the other, if at all.

On requests, the metadata will include a status code that should typically be identical to the HTTP status code returned by network library. Since some clients can not deal with HTTP status codes (e.g. web apps with Ajax), the API will provide a means of only relying on the embedded status code in the future. (See “suppress_response_codes” once available.)

Authentication and Authorization

In one embodiment, the user's username and password are passed to each API call that requires authentication. All API calls can be made over HTTPS in production.

In other embodiments, the API may provide an auth_token approach, and OAuth2 support is planned including resource owner password credential grant support.

Native Mobile Clients

System's client app can be an iOS client. The app can ship with seeded data for some values of the data model (e.g. Categories, Organization/Programs), but can be expected to “phone home” after installation to update itself.

The client app is designed to minimize hard-coded values, and to require few app update cycles for customers for strictly data model driven info.

Given the large volume of data involved with the System data model, the native app will cache as much information as possible as it learns it. Data can have expiry info associated with it so the client can make intelligent caching decisions and to reduce network activity.

The app also provides an appealing user experience, particularly around the user of the API. Custom timeouts of a reasonable duration are considered, and lengthy data results should leverage sane pagination values so some data can get in front of the customer quickly, with the rest loading in the background or on demand. Network retries are also important when initial attempts time-out or fail and are recoverable events.

The client can implement secure storage of the user's cached credentials and usage data, using industry standard best practice and the features provided by the platform's SDK. User data can be backed up and sharable across applications using SDK native features (e.g. iCloud).

The client is also designed to allow as much off-line activity as possible when a network connection is slow, spotty, or non-existent. The app caches user behavior and upload activity when it can next connect in a way that doesn't interfere with user actions or that consumes excessive resources.

Admin and Public Web Apps

In one embodiment, system's staff has access to the System's admin web app. This web app is used to curate the overall data model for the service, to provide customer support with registered users, and to view analytics data in the form of an evolving dashboard function.

The Admin app leverages a privileged set of the system's APIs. The back-end API usage will only be permitted through server to server interaction from identified instances of the apps.

Since the Admin app is a lower priority than the initial API implementation for the native app, system leverages a number of task-oriented scripts that can be run by ops on behalf of the team. These largely handle data processing tasks and will function by taking organization, program, offer, and business feeds that are processed offline into data files (e.g. CSVs), and that add or replace content.

A secondary, publicly accessible UI may be available as part of the API service deployment that provides a User password recovery service.

The public can also have access to System's support through Marketing website contact forms, social media, and possible usage in the future of helpdesk/customer interaction tools like Zendesk or Get Satisfaction.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

I claim:

1. A computer implemented method comprising:
receiving a plurality of offers from a plurality of entities;
combining offers from the plurality of offers into an offer stack, wherein all offers of the offer stack can be applied jointly to a transaction; and
presenting the offer stack to a customer.

2. The computer implemented method of claim 1, wherein the plurality of offers includes one or more of discounts, promotions, coupons, cash backs, reward points, sponsorships, loyalty points.

3. The computer implemented method of claim 1, wherein the plurality of entities includes one or more of retailers, credit card companies, banks, membership organizations, consumer associations, public clubs, private clubs, non-profit organizations, educational institutes, government agencies, transportation companies, professional societies, or lodging providers.

4. The computer implemented method of claim 1, wherein the transaction is a business-to-customer transaction, a business-to-business transaction, or a customer-to-customer transaction.

5. The computer implemented method of claim 1, wherein each offer of the offer stack has a validity period, the validity periods of all offers of the offer stack overlap on a time period during which all offers of the offer stack can be applied jointly to the transaction.

6. The computer implemented method of claim 1, further comprising:
assigning a value to each offer of the plurality of offers; and
determining conditions under which each offer of the plurality of offers can be used in combination with other offers of the plurality of offers.

7. The computer implemented method of claim 6, wherein said combining offers from the plurality of offers into an offer stack comprises combining offers from the plurality of offers into an offer stack based on the conditions.

8. The computer implemented method of claim 1, further comprising:
storing data of the offers of the plurality of offers in a database.

9. The computer implemented method of claim 1, wherein the offer stack provides an optimal way to conduct the transaction when all offers of the offer stack are applied jointly to the transaction.

10. The computer implemented method of claim 1, further comprising:
combining offers from the plurality of offers into an alternative offer stack, wherein all offers of the alternative offer stack can be applied jointly to the transaction.

11. The computer implemented method of claim 10, further comprising:
assigning a recommendation ranking to each of the offer stack and the alternative offer stack; and
listing the offer stack and the alternative offer stack, along with the recommendation rankings, to the customer.

12. The computer implemented method of claim 10, wherein said assigning a recommendation ranking to each of the offer stack and the alternative offer stack further comprises assigning a recommendation ranking to each of the offer stack and the alternative offer stack based on a preference profile of the customer.

13. The computer implemented method of claim 1, further comprising:
providing an interface for the customer to rate and/or comment on the offer stack presented.

14. The computer implemented method of claim 1, further comprising:
providing an interface for the customer to suggest an alternative offer stack, wherein all offers of the alternative offer stack can be applied jointly to the transaction.

15. The computer implemented method of claim 1, further comprising:
providing an interface for the customer to select the offer stack and to conduct the transaction by jointly applying all offers of the offer stack.

16. The computer implemented method of claim 1, wherein at least some of the entities have one or more membership programs, and at least some of the plurality of offers are presented in at least one membership program.

17. The computer implemented method of claim 1, further comprising:
receiving at least one location for each of the entities, wherein offers from a entity from the plurality entities can be applied to a transaction to be conducted in a location for said entity.

18. A system comprising:
a data acquisition module configured for receiving a plurality of offers from a plurality of entities;
a stack analysis module configured for combining offers from the plurality of offers into an offer stack, wherein all offers of the offer stack can be applied jointly to a transaction; and
a stack visualization module configured for presenting the offer stack to a customer.

19. The system of claim 18, wherein the stack visualization module is further configured for receiving feedbacks from customers.

20. The system of claim 18, wherein the stack analysis module is further configured for organizing data of the plurality of offers and determining an optimal combination of offers from the plurality of offers to be applied to the transaction.
